(19) United States
(12) Patent Application Publication
(10) Pub. No.: US 2019/0043023 A1
(43) Pub. Date: Feb. 7, 2019

(54) REAL-TIME INTER-ENTITY RESOURCE VALIDATION AUTHENTICATION SYSTEM

(71) Applicant: BANK OF AMERICA CORPORATION, Charlotte, NC (US)

(72) Inventors: Manu Jacob Kurian, Dallas, TX (US); Joseph Benjamin Castinado, North Glenn, CO (US)

(21) Appl. No.: 15/669,162

(22) Filed: Aug. 4, 2017

(51) Int. Cl. G06Q 20/04; G06Q 20/40

(52) U.S. Cl. CPC G06Q 20/042; G06Q 20/401

(57) ABSTRACT

Embodiments of the invention are directed to systems, methods, and computer program products for inter-entity resource validation authentication. In this way, the system may validate in real-time a resource distribution. The system may confirm the accuracy and authentication of a resource distribution. In this way, the system identifies via system integration resource distribution origination and stores network attributes associated therewith. The system may integrate into receiving entities and generate scanning of the resource distribution when received at a receiving institution. The system may perform hash algorithm review of the network attributes for the drafted distribution to the received distribution for validation, in real-time, of the resource distribution.

### BACKGROUND

With advancements in technology, user resource access and distribution without authorization is becoming easier. As such, manipulation of resource access, deposits, and distribution is possible.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In some embodiments, the invention is a real-time validation service for resource distribution. In this way, the system may validate a resource distribution document prior to resource distribution. Once a receiving institution receives a resource document for depositing, the validation service will provide will confirm the accuracy and authentication of the document. The system may validate several types of resource distributions. The system may be linked to a receiving institution to be able to receive resource document information from the receiving institution and compare that information to authenticated documents for confirmation of the transaction. The receiving institution may be a user or financial institution and may communicate with the system via an application for instantaneous validation. For example, a hash algorithm may be provided by the receiving institution and be associated with a check and if that hash algorithm matches a network attribute for that check then it is an authentic check. If the hash values are not equal, the transaction is deemed counterfeit. Furthermore, the system may comprise a distributed ledger for authorization within a node on a block chain.

Paper resource distribution documents have limited amount of multi-factor authentication or security associated with the distribution of the paper resource distribution documents. Thus, a need exists for advanced security and authentication of the resource distribution document within a business setting.

Embodiments of the invention relate to systems, methods, and computer program products for inter-entity resource validation, the invention comprising: integrating system application into receiving institution servers; extracting data elements associated with a generated resource distribution from a user as a network attribute; receiving, via integration of system application, communication from a receiving institution of a resource distribution request associated with the generated resource distribution; extracting data elements associated with the resource distribution request; running comparison of the data elements associated with a generated resource distribution to the data elements associated with the resource distribution request; and validating, based on complete match of date elements, resource distribution and process resource transfer in real-time.

In some embodiments, extracting data elements associated with the resource distribution request further comprises converting the extracted data elements into a hash function for searching a distributed network for the data elements associated with the generated resource distribution.

In some embodiments, running the comparison of the data elements associated with a generated resource distribution to the data elements associated with the resource distribution request further comprises comparing the network attributes of the data elements associated with a generated resource distribution to a hash algorithm converted from the data elements associated with the resource distribution request.

In some embodiments, the invention further comprises denying the resource distribution and processing of the resource transfer in real-time based on a one or more mismatches identified from the comparison.

In some embodiments, extracting data associated with the generated resource distribution from a user as a network attribute further comprises storing the network attribute on one or more nodes of a block chain distributed network coded to be identified by a search.

In some embodiments, the invention further comprises identifying generation of the resource distribution from the user via system integration into smart devices associated with the user and tracking of generation of resource distribution or user input of resource distribution generation.

In some embodiments, integrating the system application into the receiving institution servers further comprises accessing scanning capabilities of the receiving institution servers and scanning received resource distribution requests.

In some embodiments resource distribution comprises the generation of a resource distribution document, wherein a resource distribution document includes a check or person-to-person payment. In some embodiments, the data elements comprise a payee, payor, account, amount, and date.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a validation authentication system environment, in accordance with embodiments of the present invention;

FIG. 2A illustrates a centralized database architecture environment, in accordance with embodiments of the present invention;

FIG. 2B illustrates a block chain system environment architecture, in accordance with embodiments of the present invention;

FIG. 3 illustrates a high level flowchart of inter-entity resource validation authentication for resource deployment, in accordance with embodiments of the present invention;

FIG. 4 illustrates a representation of one embodiment of a resource distribution document, in accordance with embodiments of the present invention;

FIG. 5 illustrates a representation of one embodiment of a resource distribution document, in accordance with embodiments of the present invention;

FIG. 6 illustrates a process for initiation of a validation authentication, in accordance with embodiments of the present invention; and

FIG. 7 illustrates a process for validation authentication of a resource distribution, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. In some embodiments, a “marker code” as used herein may refer to one or more marks, signals, data points, or the like that may indicate a misappropriation.

In some embodiments, a “resource distribution document” as used herein may refer to any paper document or digital signal that may transfer or exchange resources, such as funds, across individuals or entities. Resource distribution documents may include checks, certified checks, automated clearing house, contract, person-to-person payments, credit card payments, debit card payments, transfers of cash, or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the invention is a real-time validation service for resource distribution. In this way, the system may validate a check or other resource distribution document prior to resource distribution. Once a receiving institution receives a resource document for depositing, the validation service will provide will confirm the accuracy and authentication of the document. The system may validate several types of transactions, from checks, P2P payments, credit card payments, debit card payments, or the like. The system may be linked to a receiving institution to be able to receive resource document information from the receiving institution and compare that information to authenticated documents for confirmation of the transaction. The receiving institution may be a user or financial institution and may communicate with the system via an application for instantaneous validation. For example, a hash algorithm may be provided by the receiving institution and be associated with a check and if that hash algorithm matches a network attribute for that check then it is an authentic check. If the hash values are not equal, the transaction is deemed counterfeit. Furthermore, the system may comprise a distributed ledger for authorization within a node on a block chain.

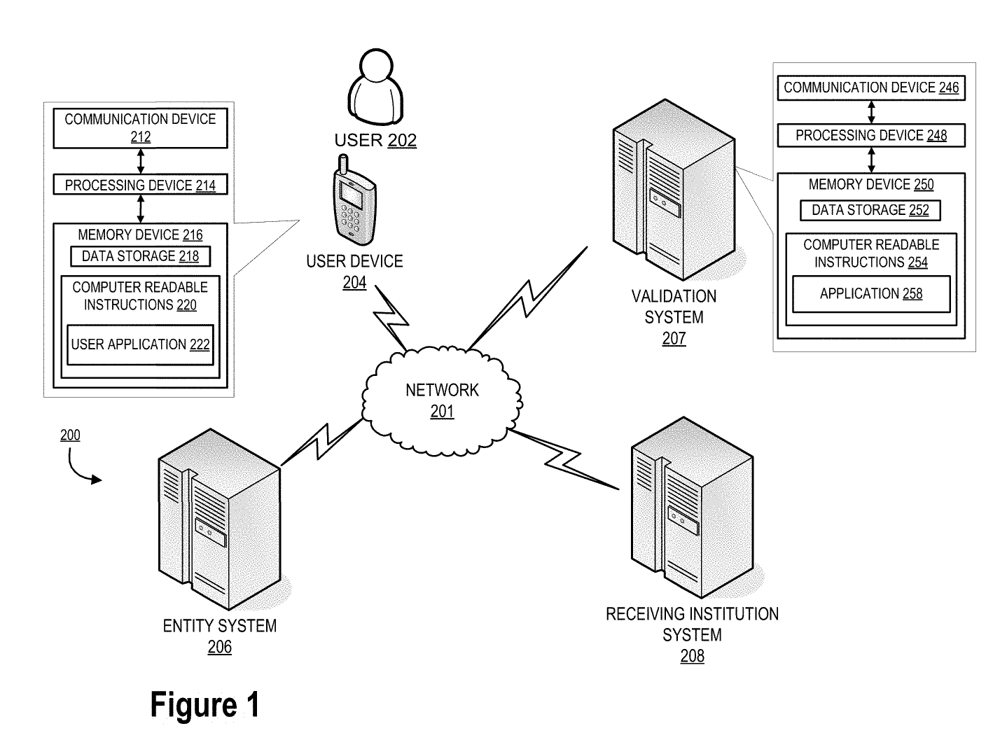

FIG. 1 illustrates a validation authentication system environment 200, in accordance with embodiments of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of real-time validation authorization for resource distribution.

As illustrated in FIG. 1, the receiving institution system 208 is operatively coupled, via a network 201 to the user device 204, validation system 207, and to the entity system 206. In this way, the receiving institution system 208 can send information to and receive information from the user device 204, validation system 207, and the entity system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is one or more individuals receiving or distributing resources. The user may have one or more accounts associated with resources for distribution of the resources such as via checks, person-to-person payments, debit cards, credit cards, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the entity system 206, the receiving institution system 208, and the validation system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to set up marker codes and communicate with the entity system 206.

As further illustrated in FIG. 1, the validation system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the receiving institution system 208, the entity system 206, and the user device 204. As such, the communication device 246 generally comprises a modem, server, or other device for communicating with other devices on the network 201.

As further illustrated in FIG. 1, the validation system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the validation system 207 the memory device 250 stores an application 258. Furthermore, the validation system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more receiving institution system 208, validation system 207, and/or user device 204.

As illustrated in FIG. 1, the entity system 206 is connected to the receiving institution system 208, user device 204, and validation system 207. The entity system 206 has the same or similar components as described above with respect to the user device 204 and the validation system 207.

As illustrated in FIG. 1, the receiving institution system 208 is connected to the validation system 207, user device 204, and entity system 206. In other embodiments, the receiving institution system 208 may be a third party system separate from the entity system 206. The receiving institution system 208 has the same or similar components as described above with respect to the user device 204 and the entity system 206. While only one receiving institution system 208 is illustrated in FIG. 1, it is understood that multiple receiving institution system 208 may make up the system environment 200.

It is understood that the servers, systems, and devices described herein illustrate one embodiment of the invention. It is further understood that one or more of the servers, systems, and devices can be combined in other embodiments and still function in the same or similar way as the embodiments described herein. The receiving institution system 208 may generally include a processing device communicably coupled to devices as a memory device, output devices, input devices, a network interface, a power source, one or more chips, and the like. The receiving institution system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the receiving institution system 208 described herein.

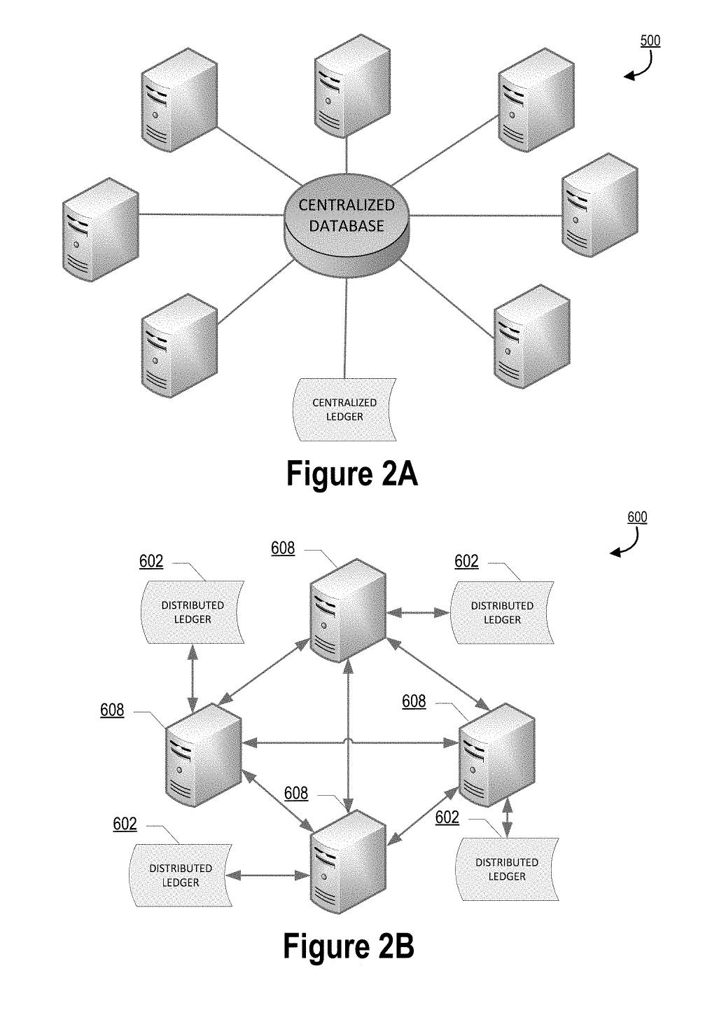

In some embodiments, the system operates in a block chain environment including a distributed ledger for authorization within a node on a block chain. FIG. 2A illustrates a centralized database architecture environment 500, in accordance with one embodiment of the present invention. The centralized database architecture comprises multiple nodes from one or more sources and converge into a centralized database. The system, in this embodiment, may generate a single centralized ledger for data received from the various nodes.

FIG. 2B provides a block chain system environment architecture 600, in accordance with one embodiment of the present invention. Rather than utilizing a centralized database of data for instrument conversion, as discussed above in FIG. 2A, various embodiments of the invention may use a decentralized block chain configuration or architecture as shown in FIG. 2B in order to facilitate the converting of an instrument from a non-secured format to a secured format. Such a decentralized block chain configuration ensures accurate mapping of user identifications over time. Accordingly, a block chain configuration may be used to maintain an accurate ledger of changes to a user's identification over time. This way tracking and maintaining user changes in identification for verification of the user's identity.

A block chain or blockchain is a distributed database that maintains a list of data records, such as real-time identifications associated with one or more users, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards or the like as an incentive to continue creating new blocks. In some embodiments, transactions type records comprise various identifications for users.

As mentioned above and referring to FIG. 2B, a block chain system 600 is typically decentralized—meaning that a distributed ledger 602 (i.e., a decentralized ledger) is maintained on multiple nodes 608 of the block chain 600. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

In some embodiments the block chain distributed network nodes 608 while part of the system may be integrated into or associated with an entity system, validation system, receiving institution system, a user system, or the like. In this way, when the block chain distributed network nodes 608 is integrated into a channel, the block chain distributed network nodes 608 may identify identifications used by the user and provide the real-time identification updates to the ledger. Furthermore, the block chain distributed network nodes 608 may be coded for identification of user identification updates. Thus, once integrated into the channel the block chain distributed network nodes 608 may identify changes or updates in identifications and provide the same to the distributed ledger for updating.

Various other specific-purpose implementations of block chains have been developed. These include distributed domain name management, decentralized crowd-funding, synchronous/asynchronous communication, decentralized real-time ride sharing and even a general purpose deployment of decentralized applications. The block chain 600 may perform one or more of the steps or functions performed by the system as discussed above with reference to FIG. 1.

In various embodiments of the invention, a block chain implementation is used to identify various identification of a user for transaction completion authorization. For real-time identification and authentication purposes, multiple active directories may be created. In such cases, a need exists to ensure mappings are not overloaded or redirected and in order to maintain a complete audit trail. The block chain configuration is used to index accounts and resources via mappings in all directories and maintain a full and visible audit trail. Mining is used, in some embodiments, to ensure that changes to specific mappings and identifications are confirmed and/or have reached a predetermined level of consensus. This also ensures unauthorized users are not manipulating the directories.

Identifications of users are mapped to the appropriate user for subsequent transaction completion via any user identification. This information must be universally available to everyone on the network, and the block chain configuration enables such information distribution. In some embodiments of the invention, such a mapping, while integral to clearing (or validating) the transaction, the mapping of the identifications to a user is maintained as private information. For example, the mapping may be maintained at a server local to the financial institution. Thus, once a requested transaction has been placed on the public block chain, the block chain network recognizes that the identification associated with the transaction is mapped to a particular user. That financial institution's server or system connected to the block chain receives the information about the user and user authentication and can validate that the transaction may be validated by looking up the appropriate mapping of the user identification. As noted, this information is not placed on the public block chain, but rather is held privately, such as on a private block chain or a “side-chain”.

One advantage of using a block chain configuration for real-time user identification is the authorization security and an opportunity for scaling. Thousands of financial institutions, merchants, and/or users may participate in a block chain real-time user identification and, therefore, the time to validation of an identification to a user may be shortened.

For example, a proposed transaction that is placed on the block chain may be validated by one or a predetermined number of nodes of the block chain in order for the transaction to proceed. The nodes may work as miners or “validators” in order to confirm the identification of a user for authorization of the transaction and is mapped to a particular, valid financial institution. This determination may be based on the fact that the financial institution that originally mapped the instrument to itself (the “originating FI”) has placed it on the block chain and in some cases, has included additional information such as a key that validates the instrument.

The block chain may be configured with a set of rules to dictate the validation of previously used identifications and validate the user for an authentication. In some embodiments, the rules dictate that the originating FI must approve all transactions for instruments mapped to that FI. In some embodiments, the rules dictate that some or all transactions may be approved by one or more validator nodes without further input from the originating FI other than the validation of the mapped instrument and resources. In some such cases, the rules dictate that the mapped instrument, when placed on the block chain also includes additional information that is useful in determining whether an identification presented by the user is authorized for completion of a transaction.

In this way, the system generates a block chain database that connects with user systems, merchant systems, financial institution systems, internet systems management systems, and/or management entities to generate a block chain database for real-time validation and authorization of resources across entities.

The block chain database generated is a decentralized block chain configuration that ensures accurate mapping of real-time user identifications that the user may be using and/or used in the past. Accordingly, a block chain configuration may be used to maintain an accurate ledger of resource distribution and authorized transactions. The generated block chain database maintains a list of data records, such as real-time and on-going timeline of authorized resource distributions. The security of which is enhanced by the distributed nature of the block chain. A block chain typically includes several nodes, which may be one or more systems, machines, computers, databases, data stores or the like operably connected with one another.

The system provides an application for validation service of resource distribution. In this way, the receiving institution, which could be an entity, an individual, or the like, may be able to scan and transmit a resource distribution document to the system for review and validation. The system may review data extracted via network attributes from the originally created resource distribution document for instant validation of authentication of the resource distribution document at the receiving institution.

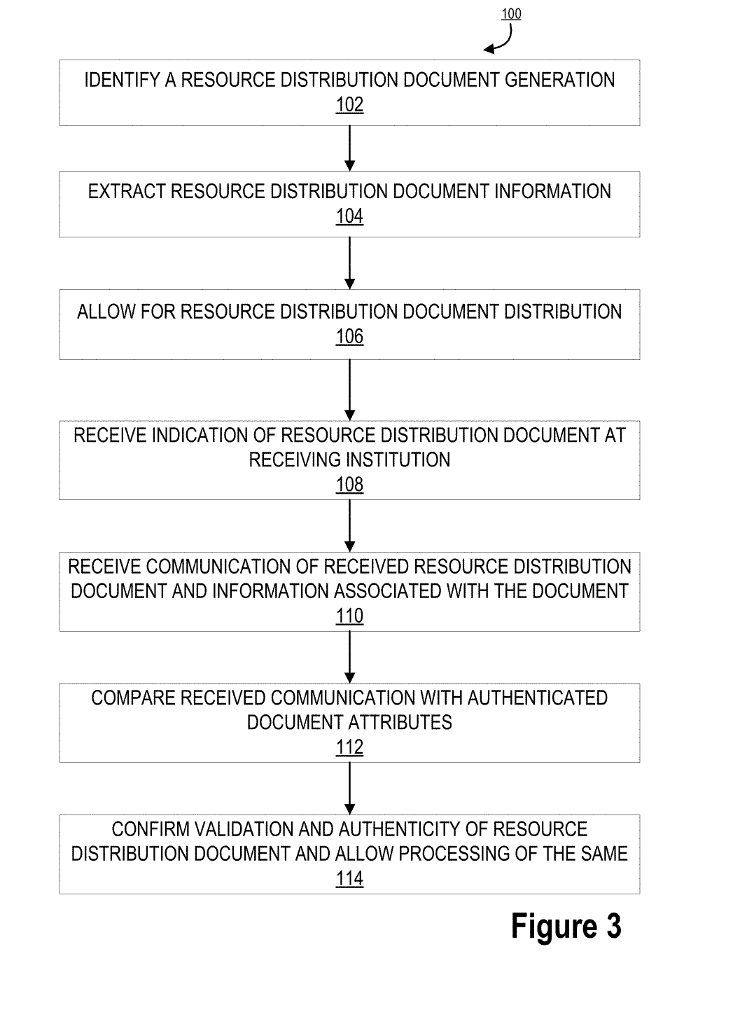

FIG. 3 illustrates a high level flowchart of inter-entity resource validation authentication for resource deployment 100, in accordance with embodiments of the present invention. The process 100 is initiated by identifying a resource distribution document being generated, as illustrated in block 102. In this way, a user, entity, end user, or the like may determine that a resource distribution document may need to be generated. The resource distribution document may be generated for one or more purposes including, but not limited to, payment, resource distribution, payroll, vendor payments, other payments, or the like. The resource distribution document generated may be a check, person-to-person payment, credit card payment, debit card payment, or the like.

As illustrated in block 104, the process 100 continues by extracting information associated with the generated resource distribution document. In this way a network attribute may be stored in association with the resource distribution document being generated. The network attribute may include the payee, payor, amount, account number, time, date, and the like associated with the resource distribution document. In some embodiments, the system extracts the data from the resource distribution document such as the payee, payor, amount, account number, time, date, and the like associated with the resource distribution document and stores it for later validation. In some embodiments, the system stores the data internally within a memory device. In other embodiments, the system may apply the resource distribution document data within a tagged distributed ledger searchable by the system for the receiving institution in the future for validation.

Next, as illustrated in block 106, the process 100 continues by allowing for the resource distribution document to be distributed. In this way, the originator of the document may finalize drafting of the document and the system may extract necessary data associated with the document. Once this occurs, the originator of the document, such as the payor, drafter of the document, or the like may distribute the document to the document receiver. The receiver or payee may be an entity, individual, group of individuals, or the like. The receiver may sign or otherwise authorize the resource distribution document and present it to a receiving institution. The receiving institution may be a financial institution, ATM, entity, individual, or the like that may deposit or otherwise exchange the resource distribution document for currency.

As illustrated in block 108, the process 100 continues by receiving an indication from a receiving institution that the resource distribution document was presented at the receiving institution for processing. The processing may include one or more of cashing, depositing, or otherwise exchanging the resource distribution document for resources, such as currency used for purchasing goods and/or services. Next, as illustrated in block 110, the process 100 continues by receiving communication from the receiving institution of the received resource distribution document which includes the information associated with the document. In this way, the receiving institution may scan, photograph, or input data from the received resource distribution document into the system via an application or the like installed within the receiving institution network.

As illustrated in block 112, the process 100 continues by comparing the received communication data with the authenticated document attributes extracted upon drafting of the resource distribution document. In this way, the system may confirm that no misappropriation of funds, modification of the document, or the like. The system may utilize a distributed ledger on a block chain system. In this way, the originally extracted document information may be stored on a distributed ledger. For example, the system may now receive a resource distribution document from a receiving institution via image captured from the receiving institution via the provided application for verification. The system may review the received data and search the distributed ledger for the originally extracted document information. The system may pull the originally extracted document information and compare it to the image provided by the receiving institution. The system may make a determination of authentication and verify the data is the same.

Finally, as illustrated in block 114, the system may confirm the validation and authenticity of the resource distribution document received at the receiving institution and allow for processing of the document.

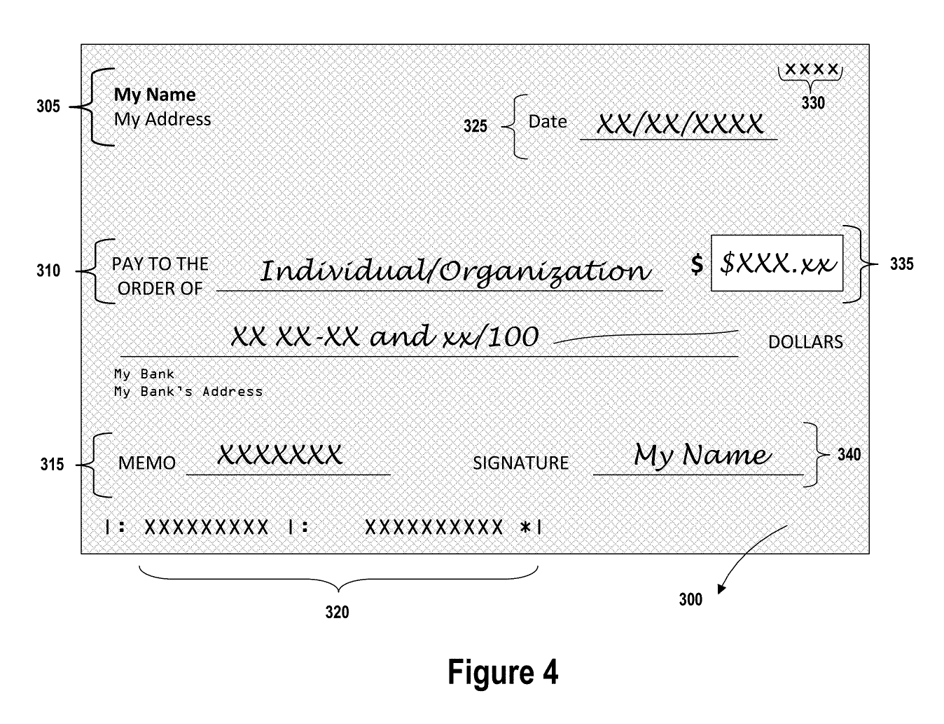

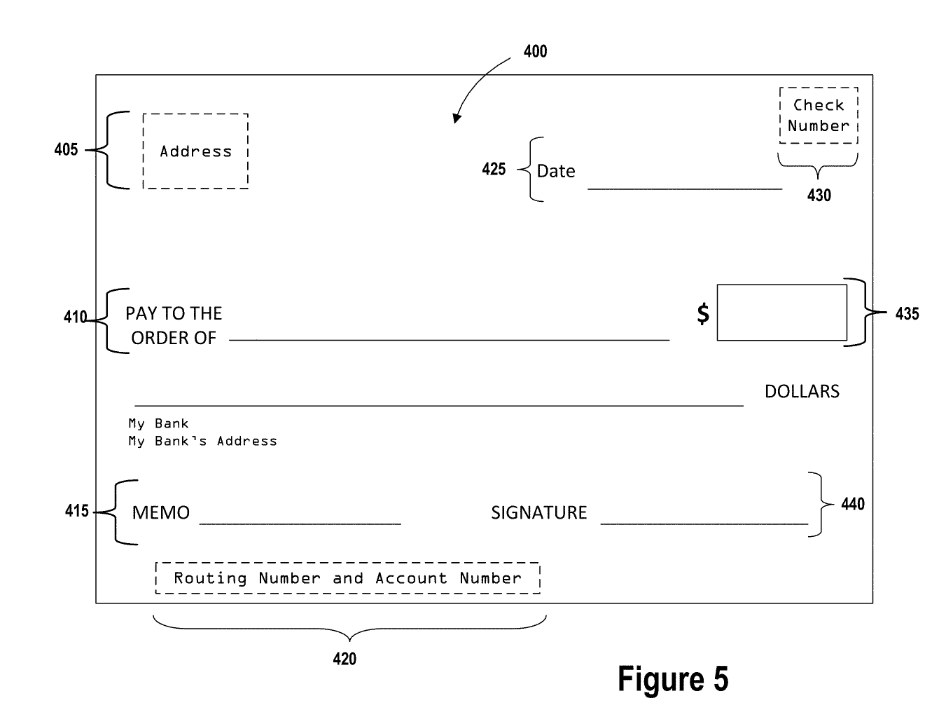

FIG. 4 illustrates a representation of one embodiment of a resource distribution document 500, in accordance with embodiments of the present invention. The resource distribution document illustrated in FIG. 5 is a check. However, one will appreciate that any financial record, financial document, or the like may be provided as a resource distribution document.

The check 300 may comprise an image of the entire check, a thumbnail version of the image of the check, individual pieces of check information, all or some portion of the front of the check, all or some portion of the back of the check, or the like. Check 300 comprises check information, wherein the check information comprises contact information 305, the payee 310, the memo description 315, the account number and routing number 320 associated with the appropriate customer account, the date 325, the check number 330, the amount of the check 335, the signature 340, or the like. In some embodiments, the check information may comprise text. In other embodiments, the check information may comprise an image.

FIG. 5 illustrates a representation of one embodiment of a resource distribution document 400, in accordance with embodiments of the present invention. Again, the resource distribution document illustrated in FIG. 5 is a check. However, one will appreciate that any financial record, financial document, or the like may be provided.

In the illustrated embodiment, the check corresponds to the entire front portion of a check, but it will be understood that the check may also correspond to individual pieces of check information, portions of a check, or the like. The check, in some embodiments, includes the format of certain types of checks associated with a bank, a merchant, an account holder, types of checks, style of checks, check manufacturer, and so forth. The check comprises check information, wherein the check information includes, for example, a contact information field 405, a payee line field 410, a memo description field 415, an account number and routing number field 420 associated with the appropriate user or customer account, a date line field 425, a check number field 430, an amount box field 435, a signature line field 440, or the like.

Each of the identified portions of the resource distribution document from FIG. 4 and/or FIG. 5 may be identified when the document is drafted. This identification may be described herein as originally extracted information or data. This will include any handwritten, typed, or otherwise applied data on the resource distribution document, such as the payee, payor, amount, time, date, account, and the like. This originally extracted data may be extracted via image optical character recognition, user input onto the system, or the like.

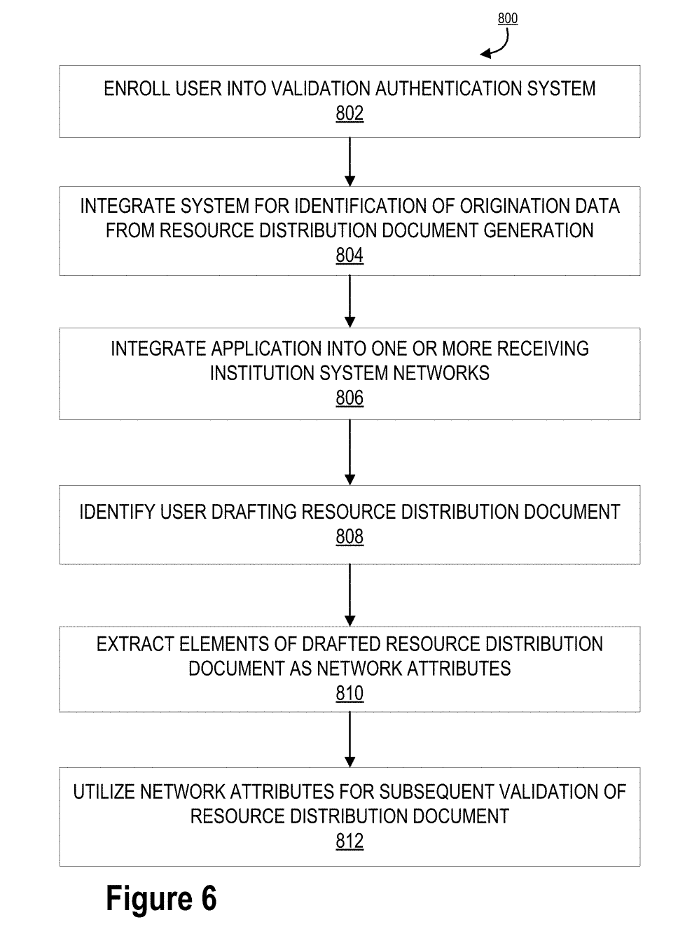

FIG. 6 illustrates a process for initiation of a validation authentication 800, in accordance with embodiments of the present invention. As illustrated in block 802, the process 800 is initiated by enrolling a user into the validation authentication system. In this way, the user may be able to enroll via his/her mobile device, integration of the system within his/her devices, or other authentication for enrollment such as telephone communication authorizing linkage of system within user devices.

Once enrolled, the authentication system may integrate applications, programs, software, and/or hardware applications within the user systems for identification of origination data from a resource distribution document generation by the user, as illustrated in block 804. Furthermore, the system may also integrate applications into one or more receiving institution system networks, as illustrated in block 806. In this way, the receiving institution, upon receiving a resource document may be able to scan or input the received document onto the system for real-time validation and processing of the document.

Next, as illustrated in block 808, the system may identify a user drafting a resource distribution document. In this way, the system may identify original data or original information from the resource distribution document. This data may be identified via user action or passively. In some embodiments, a user may scan or input the data into a device, such as a mobile device, from the drafted resource distribution document. In other embodiments, the system may via passive linkage with user devices, such as smart devices, mobile devices, home devices, or the like scan the drafted resource distribution document to identify the elements of the document as they were originally drafted by the user. In this way, the system passively gathers image data from the user devices to identify the resource distribution document being generated by the user. As illustrated in block 810, the process 800 continues by extracting the elements of the drafted resource distribution document as network attributes.

The network attributes may be stored in the memory device of the system for validation of the resource distribution upon distribution request being received at a receiving institution. In some embodiments the resource distribution request may be associated with a resource distribution document generation such as a credit card transaction generation, debit card transaction generation, person-to-person transaction initiation, cash transaction initiation, check drafting, or the like. In some embodiments, the network attributes for the resource distribution may be stored on a distributed ledger on a block chain network for subsequent validation.

Finally, as illustrated in block 812, the process 800 is completed by utilizing the network attributes for subsequent validation of the resource distribution document, thus processing the distribution. In some embodiments, the system may apply a digital lamination to the completed resource distribution request. The lamination may identify and prevent any misappropriation or discrepancies from occurring to the resource distribution at any time prior to the deposition of the resource distribution.

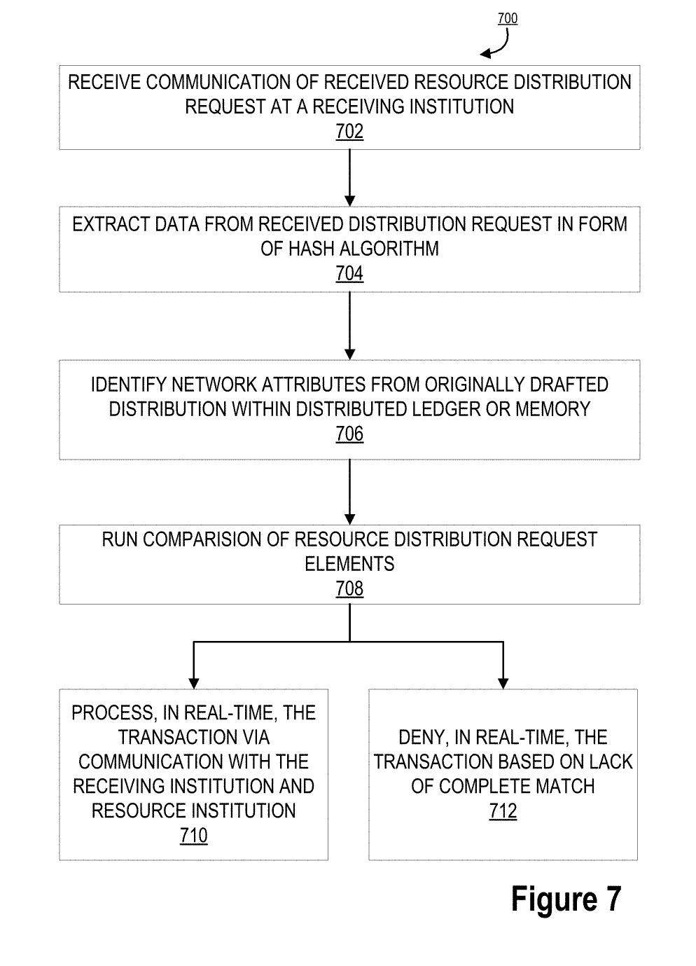

FIG. 7 illustrates a process for validation authentication of a resource distribution 700, in accordance with embodiments of the present invention. As illustrated in block 702, the process 700 is initiated by receiving a communication of a received resource distribution request at a receiving institution. In this way, the receiving institution received the resource distribution request. The receiving institution may be a financial institution, an individual (for person-to-person payments), a machine (such as an ATM), or the like. The receiving institution may scan, via a system embedded application, the received resource distribution request.

As illustrated in block 704, the process 700 continues by extracting data from the received distribution request in the form of a hash algorithm. This data includes the payee, payor, amount, time, resource distribution account, and the like. The hash algorithm or hash function is a function that is used to map the resource distribution document data. In this way, the system may form data structures in the form of hash tables for data lookup and comparison. Hash functions accelerate table or database lookup by detecting duplicated records in a large file. A cryptographic has function allows the system to verify that some input data maps to a given hash value, but if the input data is unknown, it is deliberately difficult to reconstruct it (or equivalent alternatives) by knowing the stored hash value. This is used for assuring integrity of the resource distribution document data.

Next, as illustrated in block 706 the process 700 continues by identifying network attributes from the originally drafted distribution. The elements from the originally drafted resource distribution document may be stored, when the resource distribution document was being drafted, within a distributed ledger on a block chain interface or the memory device of the system.

As illustrated in block 708, the process 700 continues by the system running a comparison of the information extracted from the resource distribution request when the user was drafting the request via network attributes to the data extracted about the resource request received at the receiving institution via the hash algorithm. The comparison may generate an exact match between the originally drafted resource distribution request and the one received at the receiving institution or there may be a mismatch of any kind. As illustrated in block 710, the process 700 continues by processing, in real-time, the transaction via communication with the receiving institution and resource institution. As such, the system identifies a perfect match between the resource distribution request received at the receiving institution and the originally drafted request. As such, the system identifies no misappropriation associated with the resource distribution based on the exact match between the extracted data. The system validates the transaction and processes the transaction in real-time for instant resource distribution without any misappropriation.

As illustrated in block 712, the system may identify a mismatch of the comparison. In some embodiments, the mismatch may be a single letter or single marking off from the original. In this way, the system may deny, in real-time, the transaction based on a lack of complete match between the resource distribution request received at the receiving institution and the originally drafted request. In some embodiments, the system triggers a halt to the real-time processing and triggers distribution of the resource distribution document to an exception processing or misappropriation representative for further evaluation.

In some embodiments, the invention is a real-time validation service for resource distribution. In this way, the system may validate a check or other resource distribution document prior to resource distribution. Once a receiving institution receives a resource document for depositing, the validation service will provide will confirm the accuracy and authentication of the document. The system may validate several types of transactions, from checks, P2P payments, credit card payments, debit card payments, or the like. The system may be linked to a receiving institution to be able to receive resource document information from the receiving institution and compare that information to authenticated documents for confirmation of the transaction. The receiving institution may be a user or financial institution and may communicate with the system via an application for instantaneous validation. For example, a hash algorithm may be provided by the receiving institution and be associated with a check and if that hash algorithm matches a network attribute for that check then it is an authentic check. If the hash values are not equal, the transaction is deemed counterfeit. Furthermore, the system may comprise a distributed ledger for authorization within a node on a block chain.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for inter-entity resource validation, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
integrate system application into receiving institution servers;
extract data elements associated with a generated resource distribution from a user as a network attribute;
receive, via integration of system application, communication from a receiving institution of a resource distribution request associated with the generated resource distribution;
extract data elements associated with the resource distribution request;
run comparison of the data elements associated with a generated resource distribution to the data elements associated with the resource distribution request; and
validate, based on complete match of date elements, resource distribution and process resource transfer in real-time.

2. The system of claim 1, wherein extracting data elements associated with the resource distribution request further comprises converting the extracted data elements into a hash function for searching a distributed network for the data elements associated with the generated resource distribution.

3. The system of claim 1, wherein running the comparison of the data elements associated with a generated resource distribution to the data elements associated with the resource distribution request further comprises comparing the network attributes of the data elements associated with a generated resource distribution to a hash algorithm converted from the data elements associated with the resource distribution request.

4. The system of claim 1, further comprising denying the resource distribution and processing of the resource transfer in real-time based on a one or more mismatches identified from the comparison.

5. The system of claim 1, wherein extracting data associated with the generated resource distribution from a user as a network attribute further comprises storing the network attribute on one or more nodes of a block chain distributed network coded to be identified by a search.

6. The system of claim 1, further comprising identifying generation of the resource distribution from the user via system integration into smart devices associated with the user and tracking of generation of resource distribution or user input of resource distribution generation.

7. The system of claim 1, wherein integrating the system application into the receiving institution servers further comprises accessing scanning capabilities of the receiving institution servers and scanning received resource distribution requests.

8. The system of claim 1, wherein resource distribution comprises the generation of a resource distribution document, wherein a resource distribution document includes a check or person-to-person payment.

9. The system of claim 1, wherein the data elements comprise a payee, payor, account, amount, and date.

10. A computer program product for inter-entity resource validation with at least one non-transitory computer-readable medium having computer-readable program code portions embodied therein, the computer-readable program code portions comprising:
an executable portion configured for integrating system application into receiving institution servers;
an executable portion configured for extracting data elements associated with a generated resource distribution from a user as a network attribute;
an executable portion configured for receiving, via integration of system application, communication from a receiving institution of a resource distribution request associated with the generated resource distribution;
an executable portion configured for extracting data elements associated with the resource distribution request;
an executable portion configured for running comparison of the data elements associated with a generated resource distribution to the data elements associated with the resource distribution request; and
an executable portion configured for validating, based on complete match of date elements, resource distribution and process resource transfer in real-time.

11. The computer program product of claim 10, wherein extracting data elements associated with the resource distribution request further comprises converting the extracted data elements into a hash function for searching a distributed network for the data elements associated with the generated resource distribution.

12. The computer program product of claim 10, wherein running the comparison of the data elements associated with a generated resource distribution to the data elements associated with the resource distribution request further comprises comparing the network attributes of the data elements associated with a generated resource distribution to a hash algorithm converted from the data elements associated with the resource distribution request.

13. The computer program product of claim 10, further comprising an executable portion configured for denying the resource distribution and processing of the resource transfer in real-time based on a one or more mismatches identified from the comparison.

14. The computer program product of claim 10, wherein extracting data associated with the generated resource distribution from a user as a network attribute further comprises storing the network attribute on one or more nodes of a block chain distributed network coded to be identified by a search.

15. The computer program product of claim 10, further comprising an executable portion configured for identifying generation of the resource distribution from the user via system integration into smart devices associated with the user and tracking of generation of resource distribution or user input of resource distribution generation.

16. The computer program product of claim 10, wherein resource distribution comprises the generation of a resource distribution document, wherein a resource distribution document includes a check or person-to-person payment.

17. A computer-implemented method for inter-entity resource validation, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
integrating system application into receiving institution servers;
extracting data elements associated with a generated resource distribution from a user as a network attribute;
receiving, via integration of system application, communication from a receiving institution of a resource distribution request associated with the generated resource distribution;
extracting data elements associated with the resource distribution request;
running comparison of the data elements associated with a generated resource distribution to the data elements associated with the resource distribution request; and
validating, based on complete match of date elements, resource distribution and process resource transfer in real-time.

18. The computer-implemented method of claim 17, wherein extracting data elements associated with the resource distribution request further comprises converting the extracted data elements into a hash function for searching a distributed network for the data elements associated with the generated resource distribution.

19. The computer-implemented method of claim 17, wherein running the comparison of the data elements associated with a generated resource distribution to the data elements associated with the resource distribution request further comprises comparing the network attributes of the data elements associated with a generated resource distribution to a hash algorithm converted from the data elements associated with the resource distribution request.

20. The computer-implemented method of claim 17, further comprising denying the resource distribution and processing of the resource transfer in real-time based on a one or more mismatches identified from the comparison.
